(19) United States
(12) Patent Application Publication
(10) Pub. No.: US 2014/0091086 A1
(43) Pub. Date: Apr. 3, 2014

(54) Stackable Container System

(71) Applicants: Steven M. Sorensen, Alpine, UT (US); Kim L. Sorensen, Alpine, UT (US); David O. Meyers, Kaysville, UT (US)

(72) Inventors: Steven M. Sorensen, Alpine, UT (US); Kim L. Sorensen, Alpine, UT (US); David O. Meyers, Kaysville, UT (US)

(73) Assignee: RUNWAY BLUE, LLC, Alpine, UT (US)

(21) Appl. No.: 13/633,864

(22) Filed: Oct. 2, 2012

(51) Int. Cl. B65D 6/00; A61J 9/00

(52) U.S. Cl. 220/4.27; 215/11.1

(57) ABSTRACT

The present invention is directed to a stackable container system. The stackable container system can comprise a beverage container, a beverage container lid, a plurality of smaller containers, and a plurality of smaller container lids. The smaller containers and smaller container lids are configured to allow any of the smaller container lids to be used on any of the smaller containers. The bottom of the beverage container and the bottom of each smaller container is also configured to allow the beverage container or smaller container to be interlocked with the top of any of the smaller container lids. In addition to storing beverage ingredients, the stackable container system can also be used to store other edible and inedible ingredients.

### CROSS-REFERENCE TO RELATED APPLICATIONS

Not Applicable.

### BACKGROUND

Beverage bottles or containers have become widely used. Such containers are often used to mix ingredients. For example, many people use these containers to mix nutritional powders into water or another liquid for consumption in conjunction with exercise.

It is often desirable to delay the mixing of the ingredients until an appropriate time. However, because such containers are often used on-the-go, it can be difficult to maintain the ingredients separate until the desired time. For example, some may use multiple containers to store the ingredients of a protein shake until after a workout is finished. Similarly, one or more separate containers may also be used to store supplements, such as vitamins or other pills, which are not mixed in the container.

Keeping track of multiple containers can be burdensome. To address this, some beverage containers have been developed that are configured to allow one or more additional containers to be attached to the beverage container. The additional containers can be used to store ingredients to be mixed in the beverage container at a later time, or to separately store other contents such as pills.

### BRIEF SUMMARY

The present invention is directed to a stackable container system. The stackable container system can be used to store ingredients for a beverage, or ingredients or substances for other edible or inedible mixes or purposes.

In one embodiment, a stackable container system of the present invention comprises a beverage container, a beverage container lid, a plurality of smaller containers, and a plurality of smaller container lids. The smaller containers and smaller container lids are configured to allow any of the smaller container lids to be used on any of the smaller containers. The bottom of the beverage container and the bottom of each smaller container is also configured to allow the beverage container or smaller container to be interlocked with the top of any of the smaller container lids.

In another embodiment, a stackable container system of the present invention comprises a beverage container, a beverage container lid, a plurality of smaller containers, a plurality of smaller container lids, and a divider that is sized to be inserted into at least one of the plurality of smaller containers when a smaller container lid is attached to the smaller container. The smaller containers and smaller container lids are configured to allow any of the smaller container lids to be used on any of the smaller containers. The bottom of the beverage container and the bottom of each smaller container is also configured to allow the beverage container or smaller container to be interlocked with the top of any of the smaller container lids.

In another embodiment, the stackable a container system of the present invention comprises a container, a container lid, a plurality of smaller containers, and a plurality of smaller container lids. The bottom of the container is configured to allow the container to be interlocked with the top of any of the at least one smaller container lid when the smaller container lid is secured to one of the at least one smaller container.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates two views of a stackable container system according to one or more embodiments of the invention;

FIG. 2 illustrates an exploded view of the stackable container system of FIG. 1; and

FIG. 3 illustrates an exploded view of two smaller containers with smaller container lids according to one or more embodiments of the invention.

### DETAILED DESCRIPTION

The present invention is directed to a stackable container system. The stackable container system can be used to store ingredients for a beverage, or ingredients or substances for other edible or inedible mixes or purposes.

In one embodiment, a stackable container system of the present invention comprises a beverage container, a beverage container lid, a plurality of smaller containers, and a plurality of smaller container lids. The smaller containers and smaller container lids are configured to allow any of the smaller container lids to be used on any of the smaller containers. The bottom of the beverage container and the bottom of each smaller container is also configured to allow the beverage container or smaller container to be interlocked with the top of any of the smaller container lids.

In another embodiment, a stackable container system of the present invention comprises a beverage container, a beverage container lid, a plurality of smaller containers, a plurality of smaller container lids, and a divider that is sized to be inserted into at least one of the plurality of smaller containers when a smaller container lid is attached to the smaller container. The smaller containers and smaller container lids are configured to allow any of the smaller container lids to be used on any of the smaller containers. The bottom of the beverage container and the bottom of each smaller container is also configured to allow the beverage container or smaller container to be interlocked with the top of any of the smaller container lids.

In another embodiment, the stackable a container system of the present invention comprises a container, a container lid, a plurality of smaller containers, and a plurality of smaller container lids. The bottom of the container is configured to allow the container to be interlocked with the top of any of the at least one smaller container lid when the smaller container lid is secured to one of the at least one smaller container.

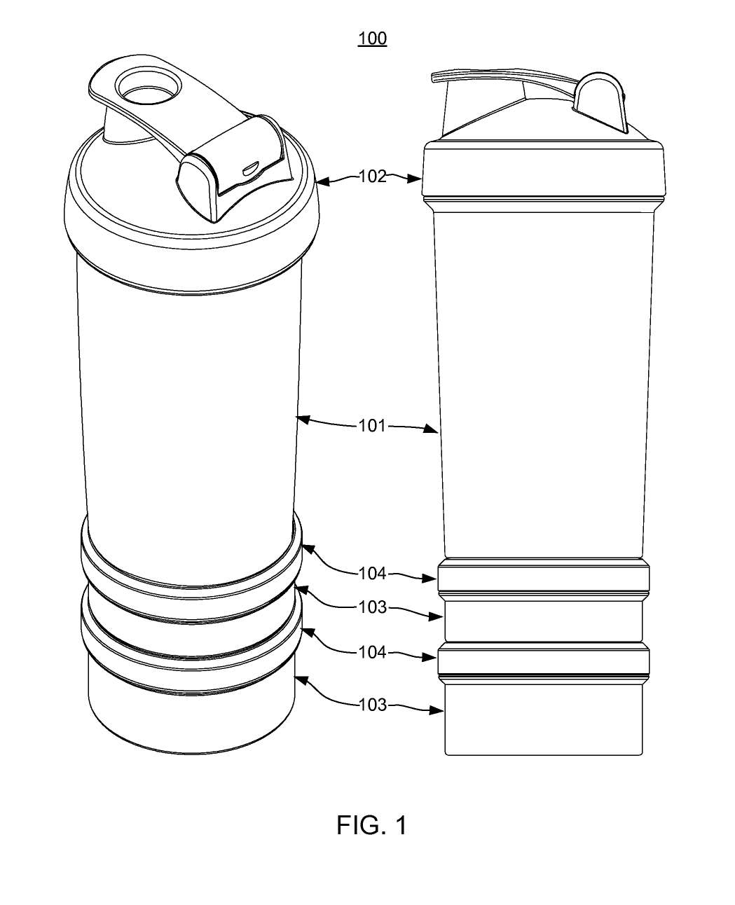

FIG. 1 illustrates two views of a stackable container system 100 in accordance with one or more embodiments of the invention. As shown, stackable container system 100 includes a beverage container 101 with a beverage container lid 102, and two smaller containers 103 that each includes a lid 104.

Although stackable container system 100 is shown having two smaller containers with lids, in some embodiments, a stackable container system can have one or more smaller containers with lids that interconnect with beverage container 101. Further, the stackable container system of the present invention is not limited to any particular type of beverage container and beverage container lid such as those shown in FIG. 1. For example, a beverage container and beverage container lid in some embodiments of the stackable container system can be a baby bottle and nipple or another type of bottle and lid for containing and/or dispensing any type of beverage or pourable substance.

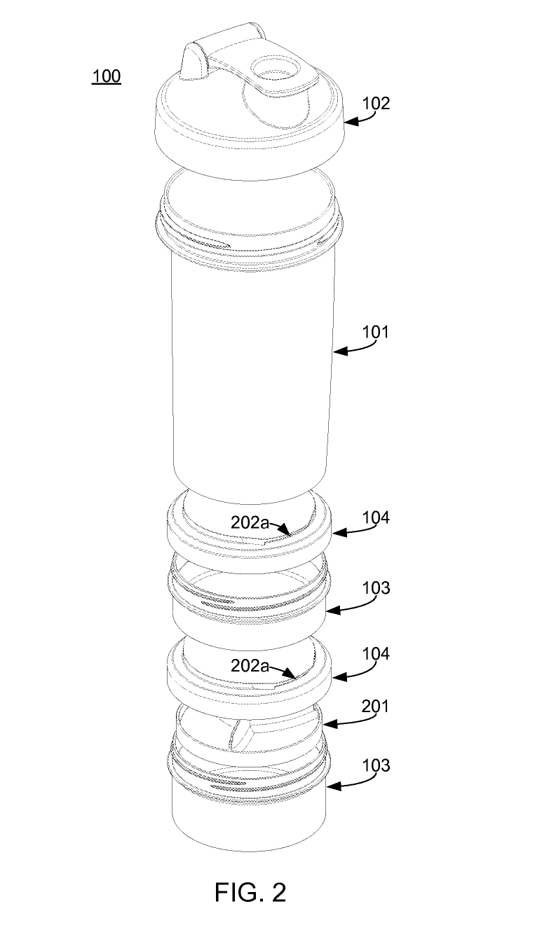

Each of lids 104 can be attached to either of smaller containers 103 (e.g. via threads (either on the inside or outside of smaller containers 103) as shown in FIG. 2 or other means as known in the art). The top of each of lids 104 is also configured to allow lid 104 to be attached to the bottom of beverage container 101 or either of smaller containers 103. In this manner, with lids 104 secured to smaller containers 103, smaller containers 103 and beverage container 101 can be interconnected to form a stack as shown in FIG. 1.

Because each container (beverage container 101 and smaller containers 103) includes a separate lid (beverage container lid 102 and lids 104), each container is independently sealable. In other words, stackable container system 100 comprises three containers that can each be sealed and used independently of the other containers, while still being interconnectable to form a single stackable container system.

FIG. 2 illustrates an exploded view of stackable container system 100. In addition to the components shown in FIG. 1, FIG. 2 also illustrates that stackable container system 100 can include a divider 201. Divider 201 can be configured to be inserted into one or more of smaller containers 103. The stackable container system of the present invention can include a single divider 201 (which may be inserted into one or more of the smaller containers), or more than one divider 201 (which may each be inserted into any of the smaller containers or which may each be configured to be inserted into a single specific smaller container).

Divider 201 is shown as having a base and three compartments. Accordingly, divider 201 provides three separate compartments for storing ingredients, pills, or other items as desired. Of course, a divider having fewer or more than three compartments could also be provided.

In some embodiments, each smaller container 103 that is configured to store divider 201 can include means for supporting divider 201. In some embodiments, this means can include a lip that extends around the inside wall of smaller container 103 on top of which divider 201 rests. One benefit of configuring smaller container 103 with a lip or other means for supporting divider 201 is that a space can be maintained within smaller container 103 and below divider 201 when divider 201 is inserted into smaller container 103. In other words, when a divider 201 providing three compartments is used, four separate compartments can be formed within smaller container 103 (one below divider 201 and three above (or within) divider 201).

Divider 201 can be configured to have a different depth than is shown in FIG. 2. In other words, the distance between the base and the top of divider 201 can be greater than or less than the distance shown in FIG. 2. Also, in some embodiments, divider 201 can be configured without a base in which case divider 201 can be placed in contact with the inside bottom surface of container 103 such that the inside bottom surface acts as a base for divider 201.

FIG. 2 also illustrates that lids 104 can be interconnected with the bottom of beverage container 101 or the bottom of a smaller container 103 using a bayonet mount. Although a bayonet mount is shown in FIG. 2, any type of connection can be used to secure lids 104 to the bottom of smaller containers 103 or beverage container 101 including by threading, snapping, twisting, sliding, or screwing lids 104 onto the bottom of the containers 101, 103.

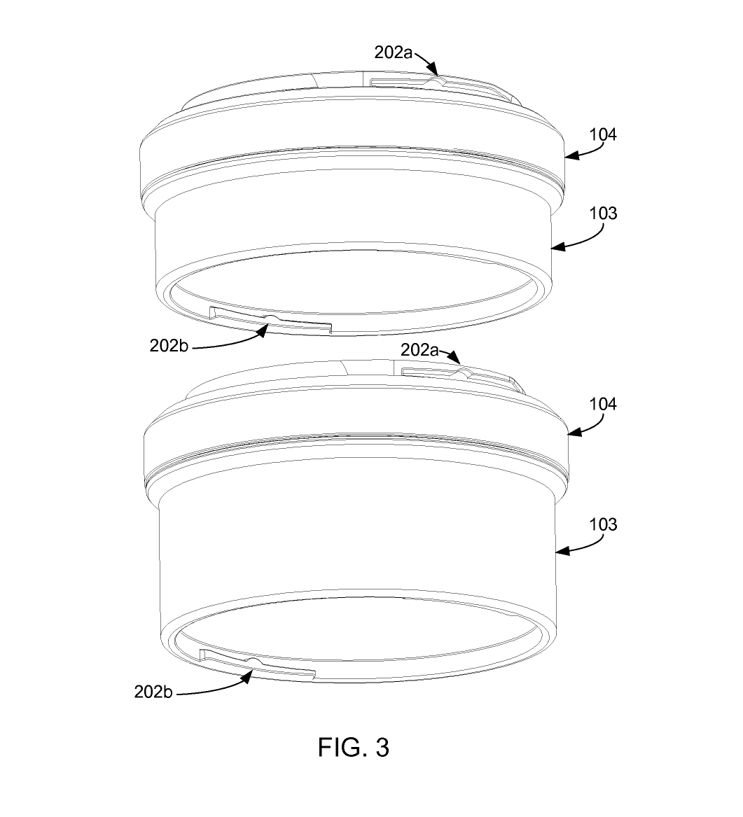

In FIG. 2, a female side 202a of the bayonet mount is shown as being formed within the top surface of lids 104. As shown in FIG. 3, a corresponding male portion 202b of the bayonet mount can be formed within the bottom of smaller containers 103. A similar male portion can also be formed within the bottom of beverage container 101. Male portion 202b can be twisted into female portion 202a to lock a lid to the bottom of a container.

In some embodiments, the female and male portions 202a, 202b of the bayonet mount can be universal thus allowing any lid 104 to be connected to the bottom of any of beverage container 101 and smaller containers 103. Further, the male and female portions could be equally formed on the top of lids 104 and the bottom of the containers respectively. However, one benefit of forming the male portion on the bottom of the containers is that it can allow a less rigid material to be used for lids 104.

The stackable container system of the present invention can be used to store ingredients separately until the user desires to mix the ingredients. For example, a user can put ingredients for a protein shake in smaller containers 103 (with or without using divider 201). Once the user desires to mix the protein shake, he can remove smaller containers 103 to add their contents to beverage container 101, add liquid if necessary to beverage container 101, and mix the contents within beverage container 101.

The stackable container system can also be used to store ingredients for and later mix the ingredients for any type of beverage or pourable substance such as, for example, baby formula, ingredients for salad dressing, ingredients for pancake batter, nutritional drink mixes, ingredients for inedible substances (e.g. paints), etc. Accordingly, the stackable container system should not be limited to any particular use (including to uses for mixing edible substances), but should extend to a stackable container system for storing and/or mixing ingredients whether the ingredients are for a beverage or other edible mix or for an inedible mix.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1-20. (canceled)

21. A stackable container system comprising:
a beverage container comprising:
a beverage container body;
a beverage container lid connecting portion disposed at least proximate an upper portion of the beverage container body;
an annular flange extending downwardly from the lower portion of the beverage container body; and
a lid connecting portion disposed on an interior wall of the annular flange of the beverage container body;
a beverage container lid selectively attached to the beverage container lid connecting portion;
a plurality of smaller containers sized and configured to be interchangeably connected to the beverage container and other smaller containers, each smaller container of the plurality of smaller containers comprising:
a smaller container body;
a threaded connecting portion disposed at least proximate an upper portion of the smaller container body;
an annular flange extending downwardly from the lower portion of the smaller container body; and
a lid connecting portion disposed on an interior wall of the annular flange of the smaller container body; and
a plurality of smaller container lids sized and configured to be selectively attached to the threaded connecting portion of the smaller containers, each smaller container lid of the plurality of smaller container lids comprising:
an annular flange sized and configured to be attached to the threaded connecting portion of the smaller containers; and
a container connecting portion that is interchangeably connectable to a lid connecting portion of a smaller container and a lid connecting portion of the beverage container.

22. The stackable container system as in claim 21, wherein the lid connecting portion of the beverage container and the lid connecting portion of the smaller container are substantially identical to allow the smaller container lid to be interchangeably attached to the smaller containers and the beverage container.

23. The stackable container system as in claim 21, wherein the lid connecting portion of the beverage container and the lid connecting portion of the smaller container comprise a male connector.

24. The stackable container system as in claim 21, wherein the lid connecting portion of the beverage container and the lid connecting portion of the smaller container comprise an inwardly extending protrusion and an engaging portion.

25. The stackable container system as in claim 21, wherein the lid connecting portion of the beverage container and the lid connecting portion of the smaller container comprise a bayonet mount.

26. The stackable container system as in claim 21, wherein the container connecting portion of the smaller container lid comprises a female connector.

27. The stackable container system as in claim 21, wherein the container connecting portion of the smaller container lid comprises a slot and a receiving portion.

28. The stackable container system as in claim 21, wherein the container connecting portion of the smaller container lids comprises a bayonet mount.

29. The stackable container system as in claim 21, further comprising a divider disposed in one or more of the smaller containers, the divider dividing the smaller container into multiple compartments.

30. The stackable container system as in claim 21, wherein any smaller container lids can be interchangeably attached to any of the plurality of smaller containers and the lid connecting portion of the beverage container.

31. The stackable container system as in claim 21, wherein the lid connecting portion of the beverage container and the lid connecting portion of the smaller container comprise an inwardly extending protrusion and an engaging portion; and
wherein the container connecting portion of the smaller container lid comprises a slot and a receiving portion.

32. The stackable container system as in claim 21, wherein the container connecting portion of the smaller container lids comprises an outwardly extending flange and a receiving portion disposed in the outwardly extending flange;
wherein the lid connecting portion of the beverage container and the lid connecting portion of the smaller containers comprise an inwardly extending flange and an engaging portion;
wherein the outwardly extending flange of the container connecting portion of the smaller container lids at least partially abuts the inwardly extending flange of the lid connecting portion; and
wherein the engaging portion of the lid connecting portion of the beverage container and the lid connecting portion of the smaller containers is at least partially disposed in the receiving portion of the container connecting portion of the smaller container lids.

33. A stackable container system comprising:
a beverage container comprising:
a beverage container body;
a threaded connecting portion disposed at least proximate an upper portion of the beverage container body;
an annular flange extending downwardly from the lower portion of the beverage container body; and
a lid connecting portion disposed on an interior portion of the annular flange of the beverage container body;
a beverage container lid attached to the threaded connecting portion of the beverage container;
a plurality of smaller containers sized and configured to be interchangeably connected to the beverage container and other smaller containers, each smaller container of the plurality of smaller containers comprising:
a smaller container body;
a threaded connecting portion disposed at least proximate an upper portion of the smaller container body;
an annular flange extending downwardly from the lower portion of the smaller container body; and
a lid connecting portion disposed on an interior portion of the annular flange of the beverage container body; and
a plurality of smaller container lids sized and configured to be selectively attached to the threaded connecting portion of the smaller containers, each smaller container lid of the plurality of smaller container lids comprising:
a first connecting structure sized and configured to interchangeably connect the lid to a smaller container; and
a second connecting structure sized and configured to connect the lid to the smaller container or the beverage container, the first connecting structure disposed on a first side of the lid and the second connecting structure disposed on a second side of the lid, the first connecting structure a different type of connecting structure than the second connecting structure.

34. The stackable container system as in claim 33, wherein the lid connecting portion of the beverage container and the lid connecting portion of the smaller container are substantially identical to allow the smaller container lid to be interchangeably attached to the smaller containers and the beverage container.

35. The stackable container system as in claim 33, wherein the lid connecting portion of the beverage container and the lid connecting portion of the smaller container comprise an inwardly extending protrusion and an engaging portion; and
wherein the container connecting portion of the smaller container lid comprises a slot and a receiving portion.

36. The stackable container system as in claim 33, wherein the container connecting portion of the smaller container lids comprises an outwardly extending flange and a receiving portion disposed in the outwardly extending flange;
wherein the lid connecting portion of the beverage container and the lid connecting portion of the smaller containers comprise an inwardly extending flange and an engaging portion;
wherein the outwardly extending flange of the container connecting portion of the smaller container lids at least partially abuts the inwardly extending flange of the lid connecting portion; and
wherein the engaging portion of the lid connecting portion of the beverage container and the lid connecting portion of the smaller containers is at least partially disposed in the receiving portion of the container connecting portion of the smaller container lids.

37. A stackable container system comprising:
a beverage container comprising:
a beverage container body;
an annular flange extending downwardly from a lower portion of the beverage container body; and
a lid connecting member extending inwardly from an inner surface of the annular flange;
a plurality of smaller containers sized and configured to be interchangeably connected to the beverage container and other smaller containers, each smaller container of the plurality of smaller containers comprising:
a smaller container body;
an annular flange extending downwardly from a lower portion of the smaller container body; and
a lid connecting member extending inwardly from an inner surface of the annular flange; and
a plurality of smaller container lids, each smaller container lid of the plurality of smaller container lids sized and configured to interchangeably connect the smaller containers and interchangeably connect the smaller containers to the beverage container, the smaller container lid comprising:
a downwardly extending annular flange;
a smaller container connecting portion on an inner surface of the downwardly extending annular flange that is sized and configured to be connected to an upper portion of the smaller containers;
an upwardly extending connecting portion sized and configured to be connected to the lid connecting member of the smaller containers and the lid connecting member of the beverage container; and
a receiving portion of the upwardly extending portion;
wherein the lid connecting member of the beverage container and the lid connecting member of the smaller container is at least partially disposed in the receiving portion of the upwardly extending portion when the smaller container lid is connected to the beverage container or the smaller container.

38. The stackable container system as in claim 37, wherein the lid connecting member extending inwardly from an inner surface of the annular flange of the beverage container is substantially identical to the lid connecting member extending inwardly from an inner surface of the annular flange of the smaller container.

39. The stackable container system as in claim 37, wherein the lid connecting member of the beverage container and the lid connecting member of the smaller container comprise an inwardly extending protrusion and an engaging portion; and
wherein the smaller container connecting portion comprises a slot and a receiving portion.

40. The stackable container system as in claim 37, wherein the smaller container connecting portion of the smaller container lid comprises an outwardly extending flange and a receiving portion disposed in the outwardly extending flange;
wherein the lid connecting member of the beverage container and the lid connecting member of the smaller containers comprise an inwardly extending flange and an engaging portion;
wherein the outwardly extending flange of the container connecting portion of the smaller container lids at least partially abuts the inwardly extending flange of the lid connecting portion; and
wherein the engaging portion of the lid connecting portion of the beverage container and the lid connecting portion of the smaller containers is at least partially disposed in the receiving portion of the container connecting portion of the smaller container lids.
